(19) United States
(12) Patent Application Publication
(10) Pub. No.: US 2025/0015621 A1
(43) Pub. Date: Jan. 9, 2025

(54) POWER SUPPLY CIRCUIT AND POWER SUPPLY SYSTEM

(71) Applicant: NINTENDO CO., LTD., Kyoto-shi (JP)

(72) Inventor: Kohei MATSUMOTO, Kyoto-shi (JP)

(21) Appl. No.: 18/891,281

(22) Filed: Sep. 20, 2024

Related U.S. Application Data
(63) Continuation of application No. PCT/JP2022/016186, filed on Mar. 30, 2022.

(51) Int. Cl. H02J 7/00

(52) U.S. Cl. CPC H02J 7/0068; H02J 7/00032; H02J 7/00712; H02J 2207/20

(57) ABSTRACT

A power supply circuit that charges a battery and supplies electric power to a load circuit includes a DC/DC converter that converts electric power at a first DC voltage supplied from an external power supply to electric power at a second DC voltage and supplies electric power at the second DC voltage to the load circuit, a charging control circuit connected in parallel to the DC/DC converter with respect to the external power supply, the charging control circuit converting electric power at the first DC voltage to electric power at a third DC voltage and supplying electric power at the third DC voltage to the battery, and a switch circuit that switches between a first mode in which electric power is supplied from the DC/DC converter to the load circuit and a second mode in which electric power is supplied from the battery to the load circuit.

This non-provisional application claims priority on and is a continuation of International Patent Application PCT/JP2022/016186 filed with the Japan Patent Office on Mar. 30, 2022, the entire contents of which are hereby incorporated by reference.

### FIELD

The present disclosure relates to a power supply circuit and a power supply system.

### BACKGROUND AND SUMMARY

Various electronic devices including a battery have been used. For charging and discharging of the battery, for example, a configuration in which power feed means supplies electric power and electric power converted by a DC/DC converter is supplied to power storage means and a load circuit has been known.

The DC/DC converter that supplies electric power to the power storage means is

configured to be suitable for precise voltage regulation, and conversion efficiency may slightly be low. Therefore, in a circuit configuration in which electric power is supplied from the DC/DC converter to the load circuit, there is a room for improvement in conversion efficiency in voltage conversion.

It would be desirable to improve conversion efficiency in voltage conversion in a power supply circuit that charges a battery and supplies electric power to a load circuit.

An exemplary embodiment provides a power supply circuit that charges a battery and supplies electric power to a load circuit. The power supply circuit includes a DC/DC converter that converts electric power at a first DC voltage supplied from an external power supply to electric power at a second DC voltage and supplies electric power at the second DC voltage to the load circuit, a charging control circuit connected in parallel to the DC/DC converter with respect to the external power supply, the charging control circuit converting electric power at the first DC voltage to electric power at a third DC voltage and supplying electric power at the third DC voltage to the battery, and a switch circuit that switches between a first mode in which electric power is supplied from the DC/DC converter to the load circuit and a second mode in which electric power is supplied from the battery to the load circuit.

According to this configuration, in the first mode, electric power at the second DC voltage resulting from conversion by the DC/DC converter is supplied to the load circuit, and in the second mode, electric power is supplied from the battery to the load circuit. The battery is charged with electric power at the third DC voltage resulting from conversion by the charging control circuit. Such mode switching can realize voltage conversion suitable for both of supply of electric power from the external power supply to the load circuit and supply of electric power from the external power supply to the battery. Thus, the power supply circuit that charges the battery and supplies electric power to the load circuit can achieve improvement in conversion efficiency in voltage conversion.

In a third mode different from the first mode and the second mode, the charging control circuit may supply at least some of electric power at the third DC voltage to the load circuit. According to this configuration, since electric power supplied from the external power supply can be supplied to the load circuit from any of the DC/DC converter and the charging control circuit, appropriate voltage conversion can be selected depending on a situation.

In a fourth mode different from the first mode, the second mode, and the third mode, both of the DC/DC converter and the charging control circuit may supply electric power to the load circuit. According to this configuration, since both of the DC/DC converter and the charging control circuit supply electric power to the load circuit, electric power can be supplied in a stable manner even when a larger amount of electric power is required in the load circuit.

Conversion efficiency in conversion by the DC/DC converter of electric power at the first DC voltage to electric power at the second DC voltage is higher than conversion efficiency in conversion by the charging control circuit of electric power at the first DC voltage to electric power at the third DC voltage. According to this configuration, supply of electric power to the load circuit can be more efficient by selection of a circuit responsible for voltage conversion depending on a situation.

When the first DC voltage is within a range of a predetermined DC voltage, the first mode may be selected, and when the first DC voltage is not within the range of the predetermined DC voltage, the third mode may be selected. According to this configuration, a circuit responsible for voltage conversion can appropriately be selected from the DC/DC converter and the charging control circuit in accordance with the first DC voltage.

The load circuit may be able to output an image to a monitor integrated with an electronic device including the load circuit and an external monitor located outside the electronic device. When the first DC voltage is within a range of a predetermined DC voltage and when the image is outputted to the external monitor, the switch circuit may make switching to the first mode. When the first DC voltage is within the range of the predetermined DC voltage and when the image is outputted to the integrated monitor, the switch circuit may make switching to the third mode. According to this configuration, since processing load in the load circuit seems to increase when the image is outputted to the external monitor, electric power adapted to increase in processing load can appropriately be provided.

In the first mode, the charging control circuit may supply electric power at the third DC voltage to the battery. According to this configuration, since the battery can be charged in parallel to supply of electric power to the load circuit by the DC/DC converter, a time period for separately charging the battery does not have to be provided.

The power supply circuit may further include a first conduction path through which an output side of the DC/DC converter and a first input portion of the switch circuit are connected to each other, a second conduction path through which an output side of the charging control circuit and a second input portion of the switch circuit are connected to each other, and a third conduction path through which an output portion of the switch circuit and the load circuit are connected to each other. According to this configuration, by controlling the switch circuit, the circuit to supply electric power to the load circuit can be selected from the DC/DC converter and the charging control circuit.

The switch circuit may include a switch that allows connection of any one of the first conduction path and the second conduction path to the third conduction path and a rectification element arranged between the second conduction path and the third conduction path, the rectification element allowing passage of a current from the second conduction path to the third conduction path. According to this configuration, in an example where electric power required by the load circuit is larger than electric power suppliable from the DC/DC converter, supply of electric power from the charging control circuit through the rectification element in addition to supply of electric power from the DC/DC converter can be realized.

The power supply circuit may further include a fourth conduction path through which the battery and the charging control circuit are connected to each other. In the second mode, electric power from the battery may be supplied to the load circuit through the second conduction path, the switch circuit, and the third conduction path. According to this configuration, since electric power from the battery is supplied to the load circuit through a path the same as a path for supply of electric power resulting from voltage conversion by the charging control circuit, a circuit configuration can be simplified.

Another exemplary embodiment provides a power supply system that charges a battery and supplies electric power to a load circuit. The power supply system includes a DC/DC converter that converts electric power at a first DC voltage supplied from an external power supply to electric power at a second DC voltage and supplies electric power at the second DC voltage to the load circuit, a charging control circuit connected in parallel to the DC/DC converter with respect to the external power supply, the charging control circuit converting electric power at the first DC voltage to electric power at a third DC voltage and supplying electric power at the third DC voltage to the battery, a switch circuit that switches between a first mode in which electric power is supplied from the DC/DC converter to the load circuit and a second mode in which electric power is supplied from the battery to the load circuit, and a power supply manager that provides a control command to the switch circuit based on electric power supplied from the external power supply. According to this configuration, the power supply manager can appropriately select between the first mode and the second mode depending on a situation.

The power supply system may further include an auxiliary device that supplies electric power at the first DC voltage. According to this configuration, electric power at the first DC voltage can be supplied in a stable manner from the auxiliary device.

The power supply manager may be provided in the auxiliary device. According to this configuration, since the power supply manager does not have to be provided in the electronic device including the power supply circuit, the electronic device can be reduced in weight.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing illustrating an

exemplary overall configuration of an electronic apparatus including a power supply circuit according to the present embodiment.

FIG. 2 shows an exemplary illustrative non-limiting drawing illustrating exemplary use in a portable mode, of the electronic apparatus including the power supply circuit according to the present embodiment.

FIG. 3 shows an exemplary illustrative non-limiting drawing illustrating exemplary use in an external power supply mode, of the electronic apparatus including the power supply circuit according to the present embodiment.

FIG. 4 shows an exemplary illustrative non-limiting drawing illustrating an exemplary internal configuration of the electronic apparatus including the power supply circuit according to the present embodiment.

FIG. 5 shows an exemplary illustrative non-limiting drawing illustrating an exemplary configuration of a power supply system including the power supply circuit according to the present embodiment.

FIG. 6 shows an exemplary illustrative non-limiting drawing illustrating an exemplary configuration of a dock according to the present embodiment.

FIG. 7 shows an exemplary illustrative non-limiting drawing illustrating an operation in a first mode of the power supply system including the power supply circuit according to the present embodiment.

FIG. 8 shows an exemplary illustrative non-limiting drawing illustrating an operation in a second mode of the power supply system including the power supply circuit according to the present embodiment.

FIG. 9 shows an exemplary illustrative non-limiting drawing illustrating an operation in a third mode of the power supply system including the power supply circuit according to the present embodiment.

FIG. 10 shows an exemplary illustrative non-limiting drawing illustrating an operation in a fourth mode of the power supply system including the power supply circuit according to the present embodiment.

FIG. 11 shows an exemplary illustrative non-limiting drawing illustrating a flowchart showing a processing procedure in selection of an operation mode in the power supply system including the power supply circuit according to the present embodiment.

FIG. 12 shows an exemplary illustrative non-limiting drawing illustrating a flowchart showing a modification of the processing procedure in selection of the operation mode in the power supply system including the power supply circuit according to the present embodiment.

FIG. 13 shows an exemplary illustrative non-limiting drawing illustrating a modification of the power supply system including the power supply circuit according to the present embodiment.

FIG. 14 shows an exemplary illustrative non-limiting drawing illustrating another modification of the power supply system including the power supply circuit according to the present embodiment.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

### A. Exemplary Overall Configuration

An exemplary overall configuration of an electronic device including a power supply circuit according to the present embodiment will initially be described. The power supply circuit according to the present embodiment is applicable to any electronic devices such as a game device, a smartphone, a tablet, and a personal computer. By way of example, the power supply circuit according to the present embodiment may be adopted for a game device as will be described later.

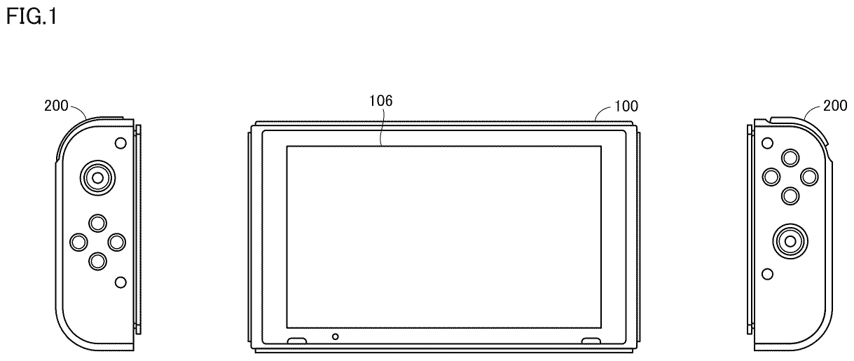

An exemplary overall configuration of an electronic apparatus 100 including the power supply circuit according to the present embodiment will be described with reference to FIG. 1. A game system 1 includes an electronic apparatus 100 representing an exemplary electronic device and one or more controllers 200.

Electronic apparatus 100 executes an application such as a game in accordance with data indicating operations by a user from each of controllers 200. Electronic apparatus 100 includes an integrated monitor 106 that outputs any image.

Each of controllers 200 accepts the operation by the user. Controller 200 may be attachable to electronic apparatus 100. While controller 200 is distant from electronic apparatus 100, electronic apparatus 100 and controller 200 exchange data therebetween through wireless communication. While controller 200 is attached to electronic apparatus 100, electronic apparatus 100 and controller 200 exchange data therebetween through wired communication and/or wireless communication.

### B. Form of Use of Electronic Apparatus 100

An exemplary form of use of electronic apparatus 100 including the power supply circuit according to the present embodiment will now be described.

A form of use in which electronic apparatus 100 operates only with electric power supplied from a mounted battery is herein referred to as a “portable mode” and a form of use in which the electronic apparatus operates with electric power supplied from an external power supply is referred to as an “external power supply mode.”

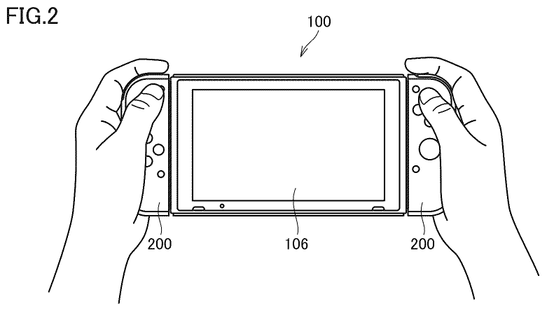

An example in which electronic apparatus 100 including the power supply circuit according to the present embodiment is used in the portable mode will be described with reference to FIG. 2. In an exemplary portable mode, the user can use electronic apparatus 100 by holding electronic apparatus 100 to which a pair of controllers 200 is attached.

In another exemplary portable mode, in a state where controller 200 has been removed and electronic apparatus 100 is placed such that the user can visually recognize monitor 106, one or more users may operate controller(s) 200 while viewing an image outputted to monitor 106.

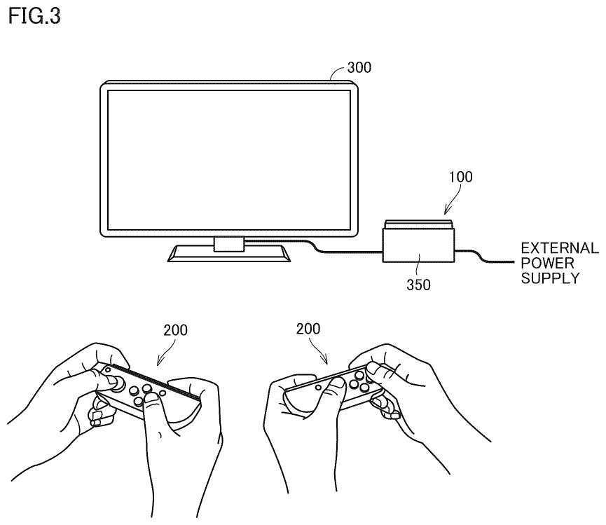

An example in which electronic apparatus 100 including the power supply circuit according to the present embodiment is used in the external power supply mode will be described with reference to FIG. 3. In a state where electronic apparatus 100 is placed on a dock 350, one or more users operate controller(s) 200 while viewing an image outputted to an external monitor 300.

In an exemplary external power supply mode, electronic apparatus 100 is supplied with electric power from an external power supply through dock 350 and supplies a signal for output of an image to external monitor 300 through dock 350.

As shown in FIGS. 2 and 3, electronic apparatus 100 (a processing circuit 50 which will be described later) can output an image to monitor 106 integrated with electronic apparatus 100 and external monitor 300 located outside electronic apparatus 100.

In the external power supply mode, electronic apparatus 100 may directly be supplied with electric power from any apparatus (a power supply adapter or the like) without dock 350 being interposed.

### C. Exemplary Internal Configuration of Electronic Apparatus 100

An exemplary internal configuration of electronic apparatus 100 including the power supply circuit according to the present embodiment will now be described.

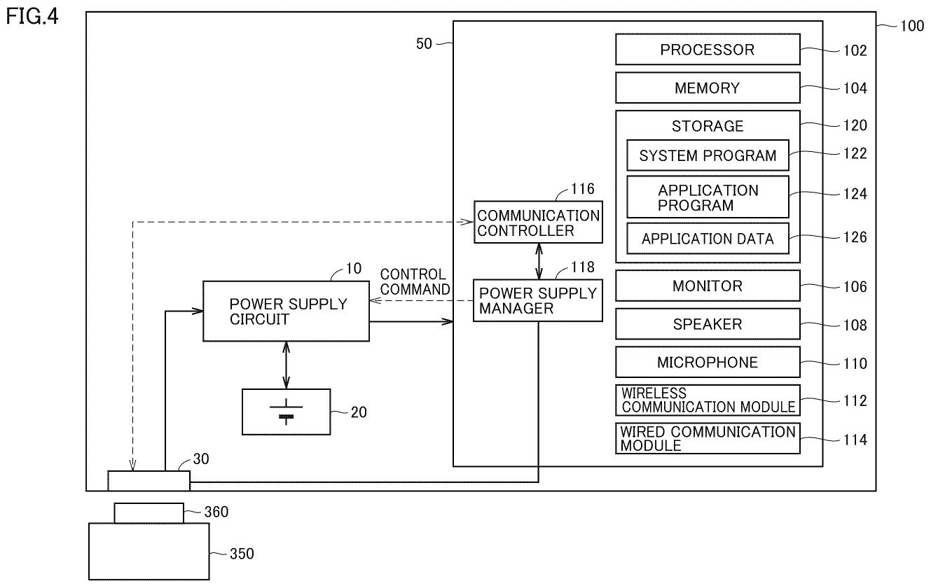

The exemplary internal configuration of electronic apparatus 100 including the power supply circuit according to the present embodiment will be described with reference to FIG. 4. Electronic apparatus 100 includes a power supply circuit 10, a battery 20, a connector 30, and processing circuit 50.

Power supply circuit 10 charges battery 20 and supplies electric power to a load circuit. More specifically, power supply circuit 10 can supply some or all of electric power supplied through connector 30 to processing circuit 50 which is the load circuit and can also charge battery 20 with some or all of electric power supplied through connector 30. A more detailed configuration of power supply circuit 10 will be described later.

Though processing circuit 50 is exemplified as the load circuit supplied with electric power by power supply circuit 10 in the description below, the load circuit may be a circuit other than processing circuit 50, or the entirety including another circuit in addition to processing circuit 50 may be defined as the load circuit.

For example, each of controllers 200 may include a not-shown battery, and electronic apparatus 100 may supply electric power for charging of the battery of controller 200 while controller 200 is attached to electronic apparatus 100. In this case, the battery of controller 200 and a circuit for charging of the battery can be the load circuit.

Battery 20 is a secondary battery that stores electric power supplied from power supply circuit 10 and discharges stored electric power. Any secondary battery such as a lithium ion battery, a nickel metal hydride battery, or a nickel-cadmium battery can be employed as battery 20.

Connector 30 is connected to dock 350 or a not-shown power supply adapter. By way of example, as the power supply adapter performs alternating-current (AC)/direct-current (DC) conversion, AC power supplied from the outside is converted to DC power and DC power is supplied to electronic apparatus 100.

Exemplary connection to a connector 360 of dock 350 will be described with reference to FIG. 4. Connector 30 is an interface for reception of electric power supplied from the outside and also an interface for communication by electronic apparatus 100 with an external apparatus. For example, a USB Type-C connector or the like that supports USB power delivery (USB PD) can be employed as connector 30.

Though FIG. 4 exemplifies connector 30 that serves as the interface for reception of electric power supplied from the outside and also as the interface for communication with an external apparatus, these interfaces may separately be prepared. Furthermore, a plurality of interfaces for reception of electric power supplied from the outside may be prepared.

Processing circuit 50 is driven with electric power supplied from power supply circuit 10. Processing circuit 50 includes a processor 102, a memory 104, a storage 120, monitor 106, a speaker 108, a microphone 110, a wireless communication module 112, a wired communication module 114, a communication controller 116, and a power supply manager 118.

Processor 102 is a processing entity for performing processing provided by electronic apparatus 100. Memory 104 is a storage device that can be accessed by processor 102, and it is implemented, for example, by a volatile storage device such as a dynamic random access memory (DRAM) or a static random access memory (SRAM). Storage 120 is implemented, for example, by a non-volatile storage device such as a flash memory.

Processor 102 performs processing as will be described later by reading a program stored in storage 120, developing the program on memory 104, and executing the program. For example, a system program 122 that provides a library necessary for execution of a program, an application program 124 composed of instruction codes for implementing any information processing, and app data 126 referred to at the time of execution of application program 124 are stored in storage 120.

The term “processor” herein encompasses processing circuitry that performs processing in accordance with an instruction code described in a program, such as a central processing unit (CPU), a micro processing unit (MPU), or a graphics processing unit (GPU) and hard-wired circuitry such as an application specific integrated circuit (ASIC) or a field programmable gate array (FPGA). In the hard-wired circuitry such as an ASIC or an FPGA, a circuit corresponding to processing to be executed is formed in advance. Furthermore, the “processor” herein also encompasses circuitry in which a plurality of functions are integrated, such as a system on chip (SoC) and combination of the processor and the hard-wired circuitry.

Monitor 106 shows an image based on a result of processing by processor 102. Speaker 108 generates any sound around electronic apparatus 100. Microphone 110 collects sound produced around electronic apparatus 100.

Wireless communication module 112 transmits and receives a wireless signal to and from any apparatus. For example, in transmission and reception of a wireless signal to and from one or more controllers 200 operated by the user, any wireless scheme such as Bluetooth®, ZigBee®, wireless LAN (IEEE 802.11), or infrared communication can be adopted for wireless communication module 112.

In transmission and reception of a wireless signal to and from a wireless relay connected to the Internet or the like, any wireless scheme such as wireless LAN (IEEE802.11) and a public wireless channel (4G, 5G, or the like) can be adopted for wireless communication unit 112.

Communication controller 116 communicates with an external apparatus such as dock 350 connected with connector 30 being interposed.

Wired communication module 114 exchanges a wired signal with attached one or more controllers 200 while controller 200 is attached to electronic apparatus 100.

Power supply manager 118 provides a control command to power supply circuit 10 in coordination with communication controller 116. Communication controller 116 may detect a voltage supplied through connector 30 and provide information on a detected voltage to power supply manager 118. Furthermore, power supply manager 118 may determine whether or not electric power is supplied from the external power supply. Selection of a mode and generation of the control command by power supply manager 118 will be described later.

### D. Exemplary Configuration of Power Supply System Including Power Supply Circuit

An exemplary configuration of a power supply system 2 including power supply circuit 10 according to the present embodiment will now be described.

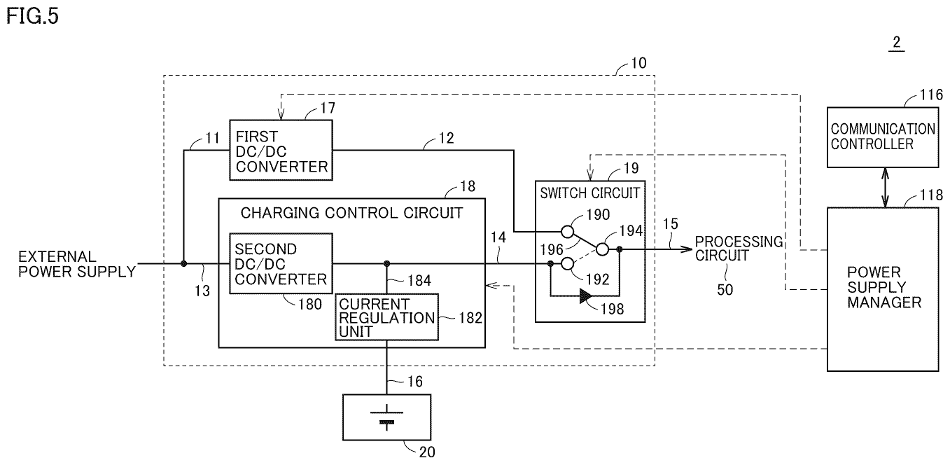

The exemplary configuration of power supply system 2 including power supply circuit 10 according to the present embodiment will be described with reference to FIG. 5. Power supply circuit 10 includes a first DC/DC converter 17 connected to the external power supply through a conduction path 11, a charging control circuit 18 connected to the external power supply through a conduction path 13 branched from conduction path 11, and a switch circuit 19 connected to a conduction path 12 on an output side of first DC/DC converter 17 and a conduction path 14 on an output side of charging control circuit 18.

Charging control circuit 18 is connected to battery 20 through a conduction path 16. In other words, power supply circuit 10 includes conduction path 16 through which battery 20 and charging control circuit 18 are connected to each other.

An output side of switch circuit 19 is connected to processing circuit 50 through a conduction path 15.

First DC/DC converter 17 converts electric power (a DC voltage V1) supplied from the external power supply to electric power at a predetermined voltage (a DC voltage V2) and supplies electric power at the predetermined voltage to processing circuit 50. Electric power from the external power supply is supplied to first DC/DC converter 17 through conduction path 11.

Charging control circuit 18 is connected in parallel to first DC/DC converter 17 with respect to the external power supply, converts electric power (DC voltage V1) supplied from the external power supply to electric power at a predetermined voltage (a DC voltage V3), and supplies electric power at the predetermined voltage to battery 20.

More specifically, charging control circuit 18 includes a second DC/DC converter 180 and a current regulation unit 182 connected to the output side of second DC/DC converter 180 through a conduction path 184. Second DC/DC converter 180 converts electric power supplied through conduction path 13 to the predetermined voltage. Current regulation unit 182 regulates a current value of electric power for charging of battery 20 and electric power discharged from battery 20.

Charging control circuit 18 estimates a charged state based on a voltage, a current, a temperature, and the like of battery 20 with a not-shown sensor, and charges battery 20 with the voltage and the current suitable for the estimated charged state.

First DC/DC converter 17 is relatively higher in conversion efficiency than second DC/DC converter 180 of charging control circuit 18. In other words, conversion efficiency in conversion by first DC/DC converter 17, of electric power (DC voltage V1) supplied from the external power supply to electric power at the predetermined voltage (DC voltage V2) is higher than conversion efficiency in conversion by charging control circuit 18, of electric power (DC voltage V1) supplied from the external power supply to electric power at the predetermined voltage (DC voltage V3).

The conversion efficiency means a ratio of output electric power to input electric power to each of first DC/DC converter 17 and second DC/DC converter 180. In general, conversion efficiency η=output electric power [W]/input electric power [W]=(output current value×output voltage value)/(input current value×input voltage value).

In the present embodiment, by way of example, a range of an operating voltage (for example, 8 to 12 [V]) allowed by first DC/DC converter 17 is narrower than a range of an operating voltage (for example, 3 to 12 [V]) allowed by second DC/DC converter 180. First DC/DC converter 17 is designed to be higher in conversion efficiency in the range of the allowed operating voltage.

First DC/DC converter 17 is higher in conversion efficiency in voltage conversion than second DC/DC converter 180 within the range of the predetermined DC voltage. The conversion efficiency in voltage conversion within the range of the predetermined DC voltage of first DC/DC converter 17 may be higher than the conversion efficiency in voltage conversion out of the range of the predetermined DC voltage.

Switch circuit 19 includes an input portion 190 connected to conduction path 12, an input portion 192 connected to conduction path 14, an output portion 194 connected to conduction path 15, and a switch 196 for connection of any one of input portion 190 and input portion 192 to output portion 194.

Power supply circuit 10 thus includes conduction path 12 through which the output side of first DC/DC converter 17 and input portion 190 of switch circuit 19 are connected to each other, conduction path 14 through which the output side of charging control circuit 18 and input portion 192 of switch circuit 19 are connected to each other, and conduction path 15 through which output portion 194 of switch circuit 19 and processing circuit 50 are connected to each other. Switch circuit 19 includes switch 196 that allows connection of any one of conduction path 12 and conduction path 14 to conduction path 15.

Switch circuit 19 includes a diode 198 representing an exemplary rectification element arranged between conduction path 14 and conduction path 15. Diode 198 allows passage of a current from conduction path 14 to conduction path 15 and cuts off the current from conduction path 15 to conduction path 14. In other words, switch circuit 19 includes the rectification element (diode 198) arranged between conduction path 14 and conduction path 15 to allow passage of the current from conduction path 14 to conduction path 15.

First DC/DC converter 17, charging control circuit 18, and switch circuit 19

operate in accordance with a control command from power supply manager 118. By way of example, power supply manager 118 provides the control command to switch circuit 19 based on electric power supplied from the external power supply.

### E. Exemplary Configuration of Dock

An exemplary configuration of dock 350 according to the present embodiment will now be described.

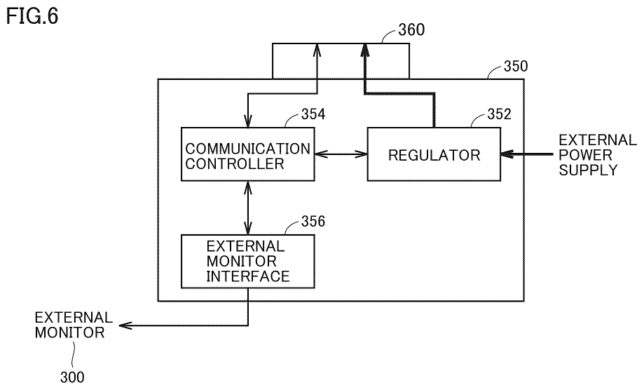

The exemplary configuration of dock 350 according to the present embodiment will be described with reference to FIG. 6. Dock 350 is an exemplary auxiliary device that supplies electric power at DC voltage V1. The auxiliary device holds electronic apparatus 100 and outputs video data from electronic apparatus 100 to an external video display device (in particular, a stationary video display device) such as a television receiver, a video monitor, or a projector through a video cable. The external video display device is referred to as external monitor 300 below. The auxiliary device according to the present embodiment supplies electric power to the electronic device held by the auxiliary device through an external power supply cable connected to the auxiliary device.

Dock 350 includes a regulator 352, a communication controller 354, and an external monitor interface 356.

Regulator 352 allows supply of electric power to electronic apparatus 100 through connector 360.

Communication controller 354 communicates with communication controller 116 of electronic apparatus 100 through connector 360.

External monitor interface 356 supplies to external monitor 300, a signal for output of an image based on a signal received through communication controller 354.

External power supplied to dock 350 may be DC power or AC power.

Regulator 352 may regulate the voltage of electric power supplied from the external power supply. At this time, the voltage may be regulated by regulator 352, in coordination with communication controller 354. In an example where AC power is supplied to dock 350, regulator 352 may include an AC/DC converter (or a rectification circuit).

### F. Operation Mode of Power Supply System

An operation mode of power supply system 2 including power supply circuit 10 according to the present embodiment will now be described.

### (f1: First Mode)

A first mode of power supply system 2 is a mode selected in a state of supply of electric power from the external power supply. In the first mode, electric power is supplied from first DC/DC converter 17 to processing circuit 50.

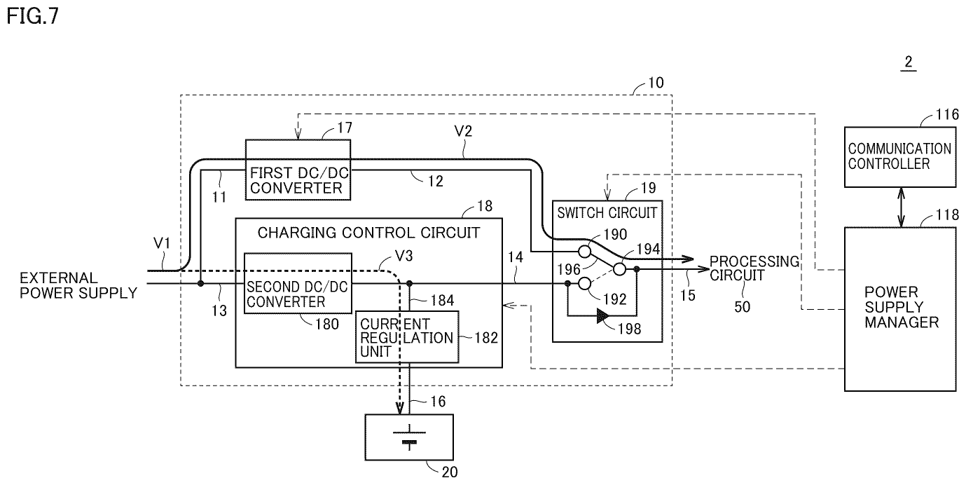

Operations in the first mode, of power supply system 2 including power supply circuit 10 according to the present embodiment will be described with reference to FIG. 7.

In the first mode, first DC/DC converter 17 supplies electric power to processing circuit 50. More specifically, electric power at DC voltage V1 supplied from the external power supply is supplied to first DC/DC converter 17 through conduction path 11. First DC/DC converter 17 converts (down-converts) DC voltage V1 to DC voltage V2. Switch 196 of switch circuit 19 is maintained in a state where it allows connection between input portion 190 and output portion 194. Consequently, electric power at DC voltage V2 is supplied to processing circuit 50 through conduction path 12, switch circuit 19, and conduction path 15.

Depending on the charged state of battery 20, battery 20 may be charged with some of electric power supplied from the external power supply. In other words, in the first mode, electric power (DC voltage V3) resulting from conversion by charging control circuit 18 is supplied to battery 20.

More specifically, electric power at DC voltage V1 supplied from the external power supply is supplied to second DC/DC converter 180 of charging control circuit 18 through conduction path 13. Second DC/DC converter 180 converts (down-converts) DC voltage V1 to DC voltage V3. Consequently, electric power at DC voltage V3 is supplied to battery 20 through conduction path 184, current regulation unit 182, and conduction path 16.

By way of example, DC voltage V1 may be set around 10 [V]. DC voltage V2 may be set around 6 [V]. DC voltage V3 may be set around 2.9 to 4.4 [V].

### (f2: Second Mode)

A second mode of power supply system 2 is a mode selected in a state without supply of electric power from the external power supply. In the second mode, electric power is supplied from battery 20 to processing circuit 50.

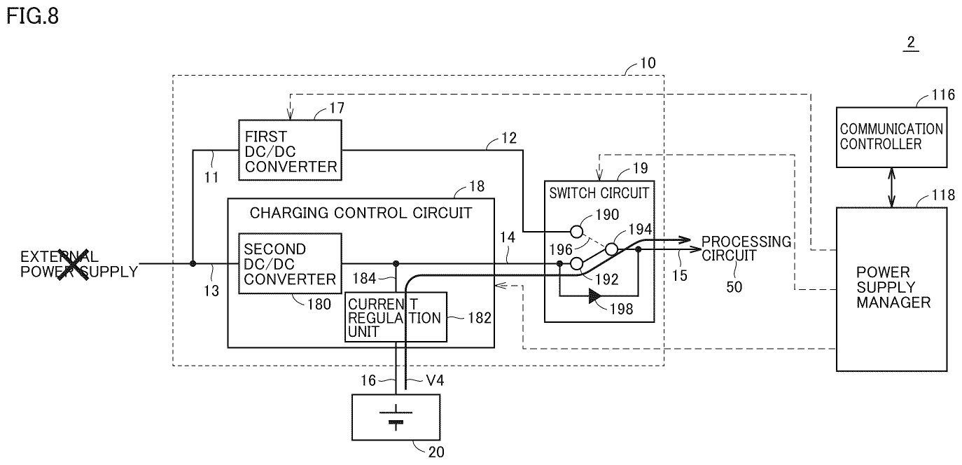

Operations in the second mode, of power supply system 2 including power supply circuit 10 according to the present embodiment will be described with reference to FIG. 8.

In the second mode, battery 20 supplies electric power to processing circuit 50. More specifically, current regulation unit 182 of charging control circuit 18 operates such that battery 20 discharges. Switch 196 of switch circuit 19 is maintained in a state where it allows connection between input portion 192 and output portion 194. Consequently, electric power at a fourth DC voltage V4 discharged from battery 20 is supplied to processing circuit 50 through conduction path 14, switch circuit 19, and conduction path 15.

Magnitude of DC voltage V4 may vary depending on the charged state of battery 20. By way of example, DC voltage V4 is around 3.0 to 4.5 [V].

### (f3: Third Mode)

A third mode of power supply system 2 is a mode selected in the state of supply of electric power from the external power supply. In the third mode, charging control circuit 18 supplies at least some of electric power at DC voltage V3 to processing circuit 50.

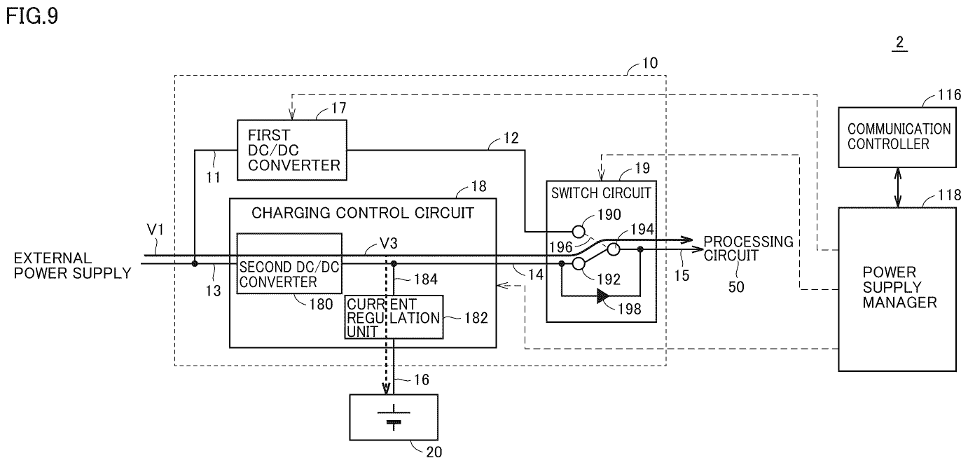

Operations in the third mode, of power supply system 2 including power supply circuit 10 according to the present embodiment will be described with reference to FIG. 9.

In the third mode, second DC/DC converter 180 of charging control circuit 18 supplies electric power to processing circuit 50. More specifically, electric power at DC voltage V1 supplied from the external power supply is supplied to second DC/DC converter 180 through conduction path 13. Second DC/DC converter 180 converts (down-converts) DC voltage V1 to DC voltage V3. Switch 196 of switch circuit 19 is maintained in the state where it allows connection between input portion 192 and output portion 194. Consequently, electric power at DC voltage V3 is supplied to processing circuit 50 through conduction path 14, switch circuit 19, and conduction path 15.

Battery 20 may be charged with some of electric power supplied from the external power supply depending on the charged state of battery 20. More specifically, some of electric power at DC voltage V3 outputted from second DC/DC converter 180 is supplied to battery 20 through conduction path 184, current regulation unit 182, and conduction path 16.

### (f4: Fourth Mode)

A fourth mode of power supply system 2 is a mode selected in the state of supply of electric power from the external power supply. In the fourth mode, both of first DC/DC converter 17 and charging control circuit 18 supply electric power to processing circuit 50.

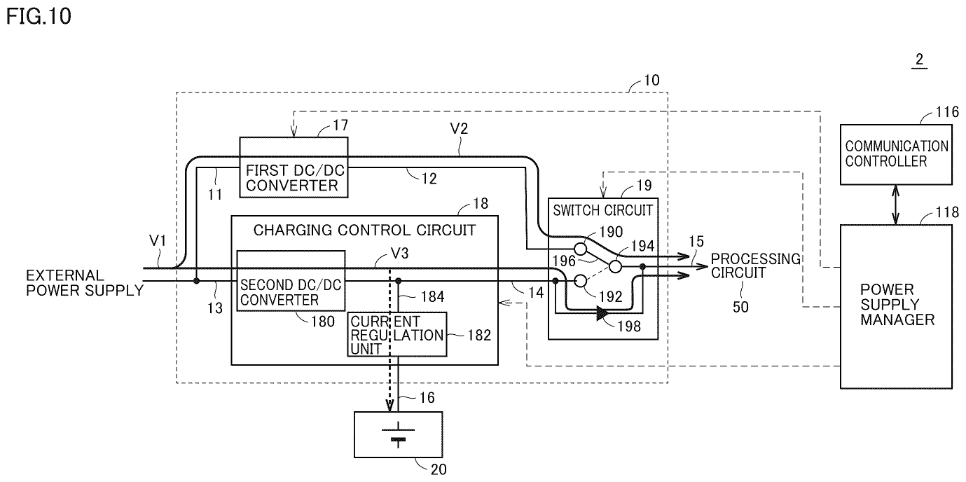

Operations in the fourth mode, of power supply system 2 including power supply circuit 10 according to the present embodiment will be described with reference to FIG. 10.

In the fourth mode, first DC/DC converter 17 and second DC/DC converter 180 of charging control circuit 18 supply electric power to processing circuit 50.

More specifically, some of electric power at DC voltage V1 supplied from the external power supply is supplied to first DC/DC converter 17 through conduction path 11. First DC/DC converter 17 converts (down-converts) DC voltage V1 to DC voltage V2. Switch 196 of switch circuit 19 is maintained in the state where it allows connection between input portion 190 and output portion 194. Consequently, electric power at DC voltage V2 is supplied to processing circuit 50 through conduction path 12, switch circuit 19, and conduction path 15.

In parallel to supply of electric power by first DC/DC converter 17, remainder of electric power at DC voltage V1 supplied from the external power supply is supplied to second DC/DC converter 180 through conduction path 13. Second DC/DC converter 180 converts (down-converts) DC voltage V1 to DC voltage V3. Electric power at DC voltage V3 is supplied to processing circuit 50 through conduction path 14, diode 198, and conduction path 15.

Since first DC/DC converter 17 and second DC/DC converter 180 supply electric power to processing circuit 50 in parallel in the fourth mode, the DC voltages that appear on the output side of switch circuit 19 are ideally substantially identical to each other. Therefore, DC voltage V3 outputted from second DC/DC converter 180 may be regulated to become higher by magnitude of a forward voltage from diode 198 than DC voltage V2 outputted from first DC/DC converter 17.

### G. Selection of Operation Mode in Power Supply System

Selection of the operation mode in power supply system 2 including power supply circuit 10 according to the present embodiment will now be described.

### (g1: Processing for Selection of Operation Mode No. 1)

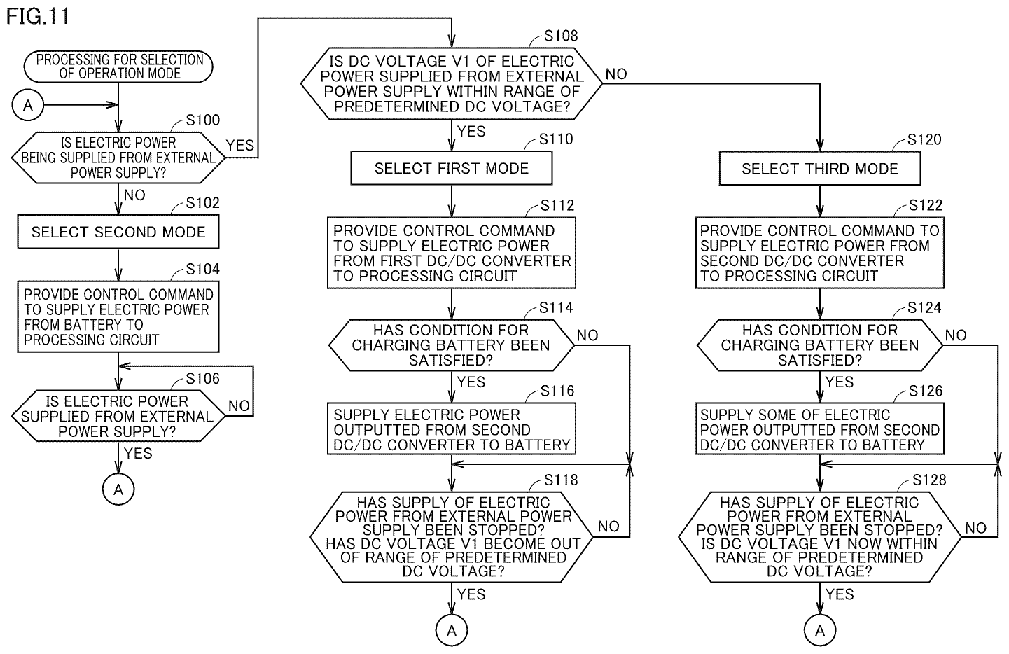

A processing procedure in selection of the operation mode in power supply system 2 including power supply circuit 10 according to the present embodiment will be described with reference to FIG. 11.

Power supply manager 118 of electronic apparatus 100 determines whether or not electric power is being supplied from the external power supply (step S100).

For example, the voltage or the like supplied through connector 30 may be detected and determination as to whether or not electric power is being supplied from the external power supply may be made. Alternatively, in an example where a configuration in which electric power is supplied from dock 350 or the power supply adapter in conformity with the USB PD is adopted, communication controller 116 determines by negotiation, the DC voltage of supplied electric power. Therefore, power supply manager 118 can also determine whether or not electric power is being supplied from the external power supply or determine the DC voltage of supplied electric power based on information from communication controller 116.

When electric power is not being supplied from the external power supply (NO in step S100), power supply manager 118 selects the second mode (step S102) and provides the control command to charging control circuit 18 to supply electric power from battery 20 to processing circuit 50 (step S104).

The state where battery 20 supplies electric power to processing circuit 50 is maintained until electric power is supplied from the external power supply (NO in step S106). When electric power is supplied from the external power supply (YES in step S106), processing in step S100 or later is repeated.

When electric power is being supplied from the external power supply (YES in step S100), power supply manager 118 determines whether or not DC voltage V1 of electric power supplied from the external power supply is within the range of the predetermined DC voltage (step S108). For example, the range of the predetermined DC voltage is set to correspond to the range of the operating voltage allowed by first DC/DC converter 17. In this case, power supply manager 118 determines whether or not electric power supplied from the external power supply can be inputted to first DC/DC converter 17.

When DC voltage V1 of electric power supplied from the external power supply is within the range of the predetermined DC voltage (YES in step S108), power supply manager 118 selects the first mode (step S110) and provides the control command to first DC/DC converter 17 to supply electric power from first DC/DC converter 17 to processing circuit 50 (step S112).

Charging control circuit 18 determines whether or not a condition for charging battery 20 has been satisfied (step S114). When the condition for charging battery 20 has been satisfied (YES in step S114), charging control circuit 18 supplies electric power outputted from second DC/DC converter 180 to battery 20 (step S116).

When the condition for charging battery 20 has not been satisfied (NO in step S114), processing in step S116 is skipped.

Then, the state where second DC/DC converter 180 supplies electric power to processing circuit 50 is maintained until supply of electric power from the external power supply is stopped or DC voltage V1 of electric power supplied from the external power supply becomes out of the range of the predetermined DC voltage (NO in step S118). When supply of electric power from the external power supply is stopped or DC voltage V1 of electric power supplied from the external power supply becomes out of the range of the predetermined DC voltage (YES in step S118), processing in step S100 or later is repeated.

When DC voltage V1 of electric power supplied from the external power supply is not within the range of the predetermined DC voltage (NO in step S108), power supply manager 118 selects the third mode (step S120) and provides the control command to charging control circuit 18 to supply electric power from second DC/DC converter 180 to processing circuit 50 (step S122).

Charging control circuit 18 determines whether or not the condition for charging battery 20 has been satisfied (step S124). When the condition for charging battery 20 has been satisfied (YES in step S124), charging control circuit 18 supplies some of electric power outputted from second DC/DC converter 180 to battery 20 (step S126).

When the condition for charging battery 20 has not been satisfied (NO in step S124), processing in step S126 is skipped.

Then, the state where second DC/DC converter 180 supplies electric power to processing circuit 50 is maintained until supply of electric power from the external power supply is stopped or DC voltage V1 of electric power supplied from the external power supply is within the range of the predetermined DC voltage (NO in step S128). When supply of electric power from the external power supply is stopped or DC voltage V1 of electric power supplied from the external power supply is now within the range of the predetermined DC voltage (YES in step S128), the processing in step S100 or later is repeated.

As described above, while electric power is supplied from the external power supply, when DC voltage V1 of electric power supplied from the external power supply is within the range of the predetermined DC voltage, the first mode may be selected, and when DC voltage V1 is not within the range of the predetermined DC voltage, the third mode may be selected.

### (g2: Processing for Selection of Operation Mode No. 2)

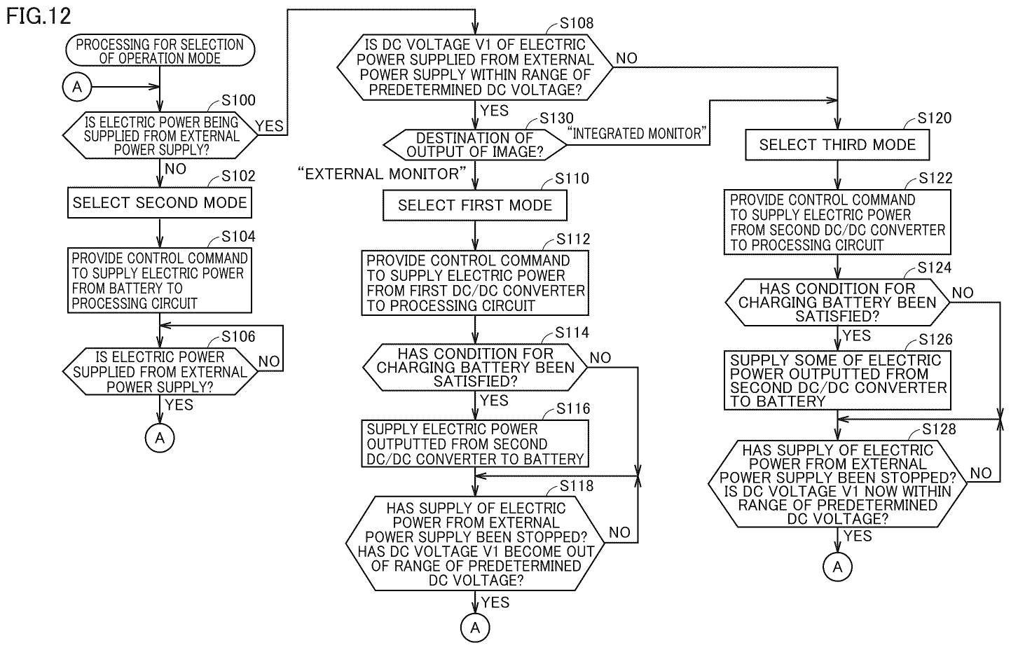

A modification of the processing procedure in selection of the operation mode in power supply system 2 including power supply circuit 10 according to the present embodiment will be described with reference to FIG. 12. A flowchart shown in FIG. 12 additionally includes step S130 as compared with the flowchart shown in FIG. 11. Description of steps similar to those in FIG. 11 will not be repeated.

When DC voltage V1 of electric power supplied from the external power supply is within the range of the predetermined DC voltage (YES in step S108), power supply manager 118 determines a destination of output of an image (step S130).

When the image is outputted to external monitor 300 (“external monitor” in step S130), power supply manager 118 selects the first mode (step S110) and performs processing in step S112 or later. When the image is outputted to integrated monitor 106 (“integrated monitor” in step S130), power supply manager 118 selects the second mode (step S120) and performs processing in step S122 or later.

Thus, while DC voltage V1 of electric power supplied from the external power supply is within the range of the predetermined DC voltage, when the image is outputted to external monitor 300, switch circuit 19 makes switching to the first mode, and when the image is outputted to integrated monitor 106, switch circuit 19 makes switching to the third mode.

For example, in a case where the number of display pixels of external monitor 300 is larger than the number of display pixels of integrated monitor 106, more processing loads are imposed in processing for generation (rendering) of the image to be outputted from external monitor 300. Therefore, by supply of electric power (selection of the first mode) from first DC/DC converter 17 higher in conversion efficiency, power loss caused in power supply circuit 10 can be lessened.

When integrated monitor 106 outputs the image, on the other hand, electric power required by processing circuit 50 is relatively low. Therefore, by supply of electric power (selection of the third mode) from second DC/DC converter 180 of charging control circuit 18 higher in general applicability, restriction as to an apparatus available as the external power supply can be relaxed. For example, the DC voltage of electric power supplied by dock 350 is in conformity with the range of the operating voltage allowed by first DC/DC converter 17, whereas the range of the operating voltage of first DC/DC converter 17 is narrower than the range of the operating voltage of second DC/DC converter 180. Therefore, in supply of electric power from the power supply adapter other than dock 350 to electronic apparatus 100, the DC voltage of electric power supplied by the power supply adapter may not be in conformity with the range of the operating voltage allowed by first DC/DC converter 17.

Then, in supply of electric power from an apparatus (power supply adapter) other than dock 350, general applicability of the external power supply can be enhanced by using second DC/DC converter 180 of charging control circuit 18 wider in range of the operating voltage.

Output of the image to external monitor 300 is premised on placement on dock 350. Therefore, when the image is outputted to integrated monitor 106 while electric power is supplied from the external power supply, electric power can be estimated as being supplied from an apparatus other than dock 350.

### (g3: Processing for Selection of Operation Mode No. 3)

When a larger amount of electric power should be supplied to processing circuit 50 with the first mode having been selected, transition to the fourth mode may be made. In the fourth mode, for example, when the first mode alone is insufficient for supply of electric power to the load circuit, electric power from second DC/DC converter 180 in addition to electric power from first DC/DC converter 17 is supplied to processing circuit 50. By providing the fourth mode, even when loads in processing circuit 50 are great, electric power can be supplied to processing circuit 50 in a stable manner and processing in processing circuit 50 can continue.

Examples where a larger amount of electric power is required include, for example, a case of execution of an application high in processing loads or charging of the battery of controller 200. Whether or not transition to the fourth mode should be made may be determined based on magnitude of electric power outputted from first DC/DC converter 17 or information from the system program executed in processing circuit 50.

### H. Modification

The power supply circuit and the power supply system including the power supply circuit according to the present embodiment may freely be modified as below.

(h1: Obtainment of DC Voltage of Electric Power Supplied from External Power Supply)

Though the configuration to obtain the DC voltage of electric power supplied after negotiation with dock 350 or the power supply adapter (in conformity with the USB PD) is exemplified by way of example in the embodiment described above, without being limited thereto, any method can be adopted.

For example, dock 350 or the power supply adapter may notify power supply circuit 10 of the DC voltage. Alternatively, power supply circuit 10 may indicate the DC voltage to dock 350 or the power supply adapter.

Alternatively, the DC voltage of electric power supplied from the external power supply may be measured.

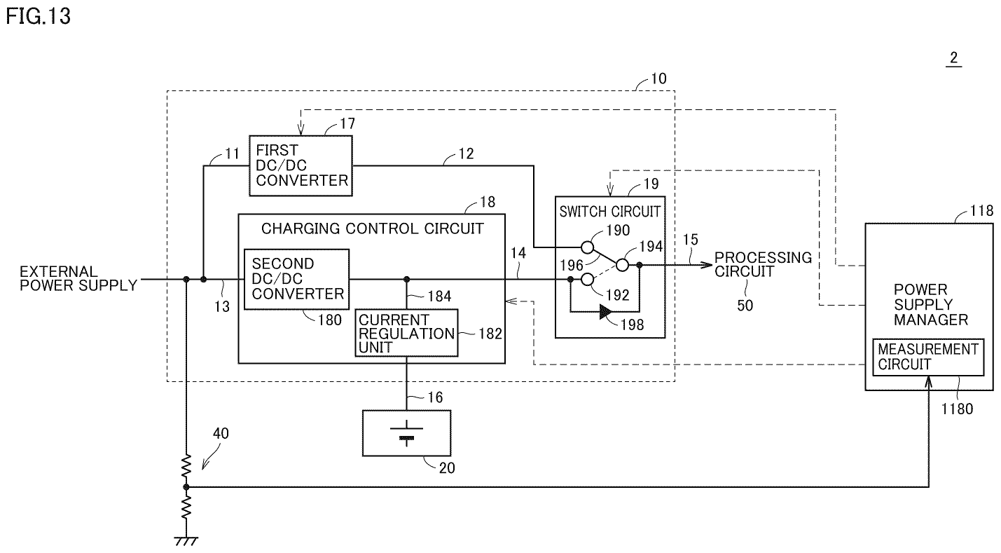

A modification of power supply system 2 including power supply circuit 10 according to the present embodiment will be described with reference to FIG. 13. Power supply circuit 10 includes a voltage division resistor 40 connected between conduction path 11 and the ground. Power supply manager 118 includes a measurement circuit 1180 that measures a voltage generated in voltage division resistor 40. The DC voltage of electric power supplied from the external power supply can be obtained based on a result of measurement by measurement circuit 1180. Measurement circuit 1180 may be arranged at any position.

### (h2: Power Supply Manager)

Though the configuration in which power supply manager 118 is prepared separately from power supply circuit 10 is exemplified in the embodiment described above, power supply manager 118 may be configured as a part of power supply circuit 10. In this case, communication controller 116 may also be configured as a part of power supply circuit 10.

Furthermore, a function corresponding to power supply manager 118 may be arranged in dock 350 representing the exemplary auxiliary device. In this case, the control command from power supply manager 118 arranged in dock 350 may be received by communication controller 116 and may be provided to first DC/DC converter 17, charging control circuit 18, and switch circuit 19 through communication controller 116.

Since the number of components necessary for electronic apparatus 100 including power supply circuit 10 can be reduced by arrangement of the function corresponding to power supply manager 118 in dock 350, electronic apparatus 100 can be reduced in size and weight.

Thus, power supply manager 118 may be arranged on the outside or in the inside of power supply circuit 10. Wherever power supply manager 118 may be arranged, power supply circuit 10 and power supply manager 118 can also collectively be referred to as power supply system 2.

### (h3: Bypass Switch)

Though the configuration in which first DC/DC converter 17 and charging control circuit 18 are each connected to the external power supply is exemplified in the embodiment described above, electric power from the external power supply may be supplied to first DC/DC converter 17 through charging control circuit 18.

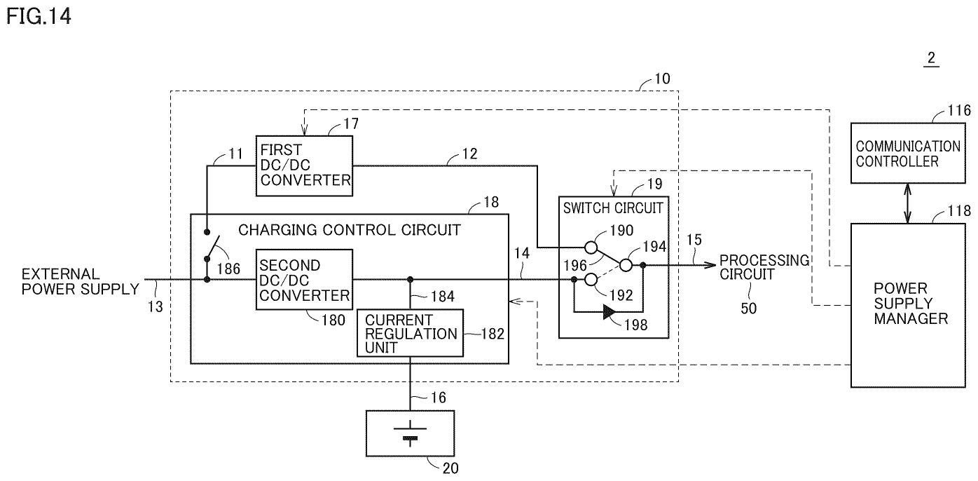

Another modification of power supply system 2 including power supply circuit 10 according to the present embodiment will be described with reference to FIG. 14. Charging control circuit 18 includes a switch 186 arranged in conduction path 11 through which the external power supply and first DC/DC converter 17 are connected to each other.

Charging control circuit 18 drives switch 186 to on in the first mode and/or the fourth mode. Electric power from the external power supply is thus supplied to first DC/DC converter 17. By providing switch 186, supply of electric power to first DC/DC converter 17 can be cut off in the third mode.

(h4: Processing in Supply of Electric Power from External Power Supply Other than Dock 350)

The configuration to obtain the DC voltage of electric power supplied by negotiation with dock 350 or the power supply adapter (in conformity with the USB PD) is exemplified by way of example in the embodiment described above. In negotiation, identification information for identification of the external power supply may be obtained. Therefore, whether dock 350 or another apparatus (the power supply adapter or the like) is connected as the external power supply can also be determined.

Therefore, power supply manager 118 may select the first mode only when connection to dock 350 is established. In this case, in supply of electric power from the external power supply other than dock 350, the third mode may be selected. Since second DC/DC converter 180 wider in range of the allowed operating voltage supplies electric power in the third mode, influence on supply of electric power to processing circuit 50 can be suppressed even when the DC voltage of electric power supplied from the external power supply is varied.

### (h5: First Mode)

Though exemplary processing for selection of the first mode when DC voltage V1 of electric power supplied from the external power supply is within the range of the predetermined DC voltage is described in the embodiment above, placement of electronic apparatus 100 on dock 350 may be added as the condition for selection of the first mode, in addition to the condition for DC voltage V1 of electric power supplied from the external power supply. In other words, when DC voltage V1 of electric power supplied from the external power supply is within the range of the predetermined DC voltage and when electronic apparatus 100 is placed on dock 350, the first mode may be selected.

Any method may be adopted as a method of determination by electronic apparatus 100, as to whether or not it is placed on dock 350. For example, whether or not the electronic apparatus is placed on dock 350 may be determined based on whether or not it can receive predetermined identification information from dock 350.

### I. Advantage

According to the present embodiment, conversion efficiency in voltage conversion can be improved in the power supply circuit that charges the battery and supplies electric power to the load circuit.

Although the present disclosure has been described and illustrated in detail, it is clearly understood that the same is by way of illustration and example only and is not to be taken by way of limitation, the scope of the present disclosure being interpreted by the terms of the appended claims.

1. A power supply circuit that charges a battery and supplies electric power to a load circuit, the power supply circuit comprising:
a DC/DC converter that converts electric power at a first DC voltage supplied from an external power supply to electric power at a second DC voltage and supplies electric power at the second DC voltage to the load circuit;
a charging control circuit connected in parallel to the DC/DC converter with respect to the external power supply, the charging control circuit converting electric power at the first DC voltage to electric power at a third DC voltage and supplying electric power at the third DC voltage to the battery; and
a switch circuit that switches between a first mode in which electric power is supplied from the DC/DC converter to the load circuit and a second mode in which electric power is supplied from the battery to the load circuit.

2. The power supply circuit according to claim 1, wherein in a third mode different from the first mode and the second mode, the charging control circuit supplies at least some of electric power at the third DC voltage to the load circuit.

3. The power supply circuit according to claim 2, wherein
in a fourth mode different from the first mode, the second mode, and the third mode, both of the DC/DC converter and the charging control circuit supply electric power to the load circuit.

4. The power supply circuit according to claim 2, wherein
conversion efficiency in conversion by the DC/DC converter of electric power at the first DC voltage to electric power at the second DC voltage is higher than conversion efficiency in conversion by the charging control circuit of electric power at the first DC voltage to electric power at the third DC voltage.

5. The power supply circuit according to claim 2, wherein
when the first DC voltage is within a range of a predetermined DC voltage, the first mode is selected, and
when the first DC voltage is not within the range of the predetermined DC voltage, the third mode is selected.

6. The power supply circuit according to claim 2, wherein
the load circuit can output an image to a monitor integrated with an electronic device including the load circuit and an external monitor located outside the electronic device,
when the first DC voltage is within a range of a predetermined DC voltage and when the image is outputted to the external monitor, the switch circuit makes switching to the first mode, and
when the first DC voltage is within the range of the predetermined DC voltage and when the image is outputted to the integrated monitor, the switch circuit makes switching to the third mode.

7. The power supply circuit according to claim 1, wherein
in the first mode, the charging control circuit supplies electric power at the third DC voltage to the battery.

8. The power supply circuit according to claim 1, further comprising:
a first conduction path through which an output side of the DC/DC converter and a first input portion of the switch circuit are connected to each other;
a second conduction path through which an output side of the charging control circuit and a second input portion of the switch circuit are connected to each other; and
a third conduction path through which an output portion of the switch circuit and the load circuit are connected to each other.

9. The power supply circuit according to claim 8, wherein
the switch circuit comprises
a switch that allows connection of any one of the first conduction path and the second conduction path to the third conduction path, and
a rectification element arranged between the second conduction path and the third conduction path, the rectification element allowing passage of a current from the second conduction path to the third conduction path.

10. The power supply circuit according to claim 8, further comprising a fourth conduction path through which the battery and the charging control circuit are connected to each other, wherein
in the second mode, electric power from the battery is supplied to the load circuit through the second conduction path, the switch circuit, and the third conduction path.

11. A power supply system that charges a battery and supplies electric power to a load circuit, the power supply system comprising:
a DC/DC converter that converts electric power at a first DC voltage supplied from an external power supply to electric power at a second DC voltage and supplies electric power at the second DC voltage to the load circuit;
a charging control circuit connected in parallel to the DC/DC converter with respect to the external power supply, the charging control circuit converting electric power at the first DC voltage to electric power at a third DC voltage and supplying electric power at the third DC voltage to the battery;
a switch circuit that switches between a first mode in which electric power is supplied from the DC/DC converter to the load circuit and a second mode in which electric power is supplied from the battery to the load circuit; and
a power supply manager that provides a control command to the switch circuit based on electric power supplied from the external power supply.

12. The power supply system according to claim 11, further comprising an auxiliary device that supplies electric power at the first DC voltage.

13. The power supply system according to claim 12, wherein
the power supply manager is provided in the auxiliary device.

14. The power supply system according to claim 11, wherein
in a third mode different from the first mode and the second mode, the charging control circuit supplies at least some of electric power at the third DC voltage to the load circuit.

15. The power supply system according to claim 14, wherein
in a fourth mode different from the first mode, the second mode, and the third mode, both of the DC/DC converter and the charging control circuit supply electric power to the load circuit.

16. The power supply system according to claim 14, wherein
conversion efficiency in conversion by the DC/DC converter of electric power at the first DC voltage to electric power at the second DC voltage is higher than conversion efficiency in conversion by the charging control circuit of electric power at the first DC voltage to electric power at the third DC voltage.

17. The power supply system according to claim 14, wherein
when the first DC voltage is within a range of a predetermined DC voltage, the first mode is selected, and
when the first DC voltage is not within the range of the predetermined DC voltage, the third mode is selected.

18. The power supply system according to claim 14, wherein
the load circuit can output an image to a monitor integrated with an electronic device including the load circuit and an external monitor located outside the electronic device,
when the first DC voltage is within a range of a predetermined DC voltage and when the image is outputted to the external monitor, the switch circuit makes switching to the first mode, and
when the first DC voltage is within the range of the predetermined DC voltage and when the image is outputted to the integrated monitor, the switch circuit makes switching to the third mode.

19. The power supply system according to claim 11, wherein in the first mode, the charging control circuit supplies electric power at the third DC voltage to the battery.

20. The power supply system according to claim 11, further comprising:
a first conduction path through which an output side of the DC/DC converter and a first input portion of the switch circuit are connected to each other;
a second conduction path through which an output side of the charging control circuit and a second input portion of the switch circuit are connected to each other; and
a third conduction path through which an output portion of the switch circuit and the load circuit are connected to each other.

21. The power supply system according to claim 20, wherein
the switch circuit comprises
a switch that allows connection of any one of the first conduction path and the second conduction path to the third conduction path, and
a rectification element arranged between the second conduction path and the third conduction path, the rectification element allowing passage of a current from the second conduction path to the third conduction path.

22. The power supply system according to claim 20, further comprising a fourth conduction path through which the battery and the charging control circuit are connected to each other, wherein
in the second mode, electric power from the battery is supplied to the load circuit through the second conduction path, the switch circuit, and the third conduction path.
